(19) United States
(12) Patent Application Publication
(10) Pub. No.: US 2013/0248669 A1
(43) Pub. Date: Sep. 26, 2013

(54) CONNECTION DEVICE FOR CONNECTING WITH A CHAIR AND ASSEMBLING WITH A SUPPORTER FOR SUPPORTING ELECTRONIC DEVICES

(71) Applicant: Chi-Jui Liu, Taipei Hsien (TW)

(72) Inventor: Chi-Jui Liu, Taipei Hsien (TW)

(21) Appl. No.: 13/429,434

(22) Filed: Mar. 25, 2012

(51) Int. Cl. F16M 13/02

(52) U.S. Cl. 248/226.11

(57) ABSTRACT

A connection device for connecting with a chair and assembling with a supporter for supporting electronic devices comprises a connection unit for clamping to a leg of a chair; a telescopic slider having one end connected to the connection unit and for adjusting a distance to a computer chair; a movable supporter connected to the another end of the telescopic slider; the movable supporter being movable with respective to the chair and being pivotably connected to other element so that an object can be fixed to the chair.

### FIELD OF THE INVENTION

The present invention relates to connection devices, and in particular to a connection device for connecting with a chair and assembling with a supporter for supporting electronic devices.

### DESCRIPTION OF THE PRIOR ART

In currently life, more and more consumer's electronic devices are used for providing conveniences in life. In the prior art, a chair with a further function for supporting a computer (in the following, it is called as a computer chair) can reduce the burden of arms. The chair is a base with five claws. Each claw is installed with a roller so that the chair is movable. A center of the chair is a telescopic shaft and the seat of the chair is rotatable so that in operation of a computer, the user can adjust the position thereof rapidly and easily. A handle of the chair is added with an arm supporting plate and a mouse plate for arm supporting and supporting of a mouse. However, in this device, the notebook computer or tablet computer is still placed on the legs of the user.

However, above mentioned prior art, the user's location is fixed. When the user does not operate the computer, the user must carefully return the computer to a storage place and must avoid the computer connecting lines to be hooked. Thus the overall operation is not convenient and not user friendly.

Thus, there is an eager demand for a novel device which can improve above mentioned defect so as to provide a convenient device to users.

### SUMMARY OF THE PRESENT INVENTION

Accordingly, the primary object of the present invention is to provide a connection device for connecting with a chair and assembling with a supporter for supporting electronic devices, wherein the general used chair can be converted into a computer chair as defined in above background of the invention by adding the connection device of the present invention. Thus a computer (or other electronic device) can be located firmly in front of a chair by which the user can operate the computer (or electronic device) easily and conveniently without any desk. If the chair has rolling wheels on the base thereof, the chair with the computer (or electronic device) is movable so that the user can operate the computer (or electronic device) at a desired place. Furthermore, since no desk is needed, the space required is saved. If the computer is not used, the connection device can be detached from the chair easily and quickly for storage.

### SUMMARY OF THE INVENTION

To achieve above object, the present invention provides a connection device for connecting with a chair and assembling with a supporter for supporting electronic devices, comprising: a connection unit for clamping to a leg of a chair; a telescopic slider having one end connected to the connection unit and for adjusting a distance to a computer chair; a movable supporter connected to the another end of the telescopic slider; the movable supporter being movable with respective to the chair and being pivotably connected to other element so that an object can be fixed to the chair.

### BRIEF DESCRIPTION OF THE DRAWINGS

FIG. 1 is a perspective view of the present invention.

FIG. 2 is an exploded perspective view of the present invention.

FIG. 3 is a perspective view showing the application of the present invention.

### DETAILED DESCRIPTION OF THE INVENTION

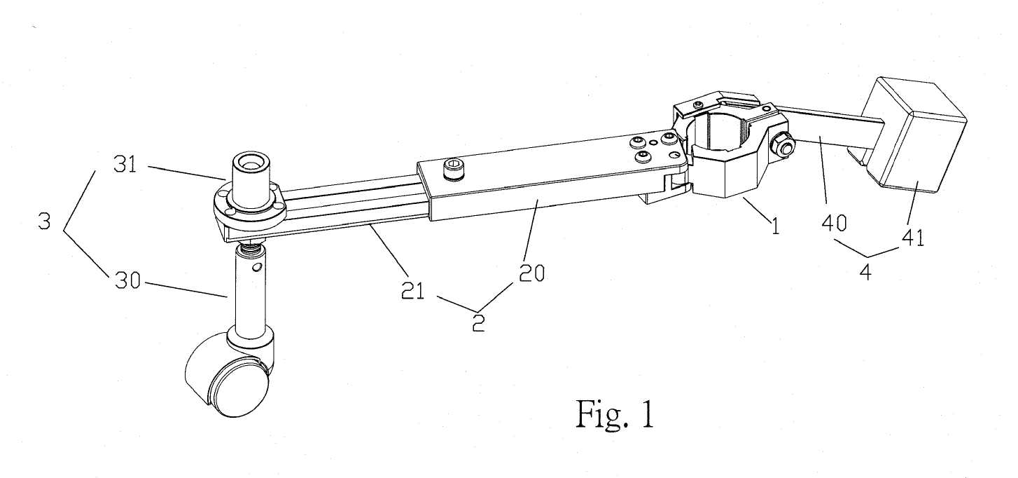

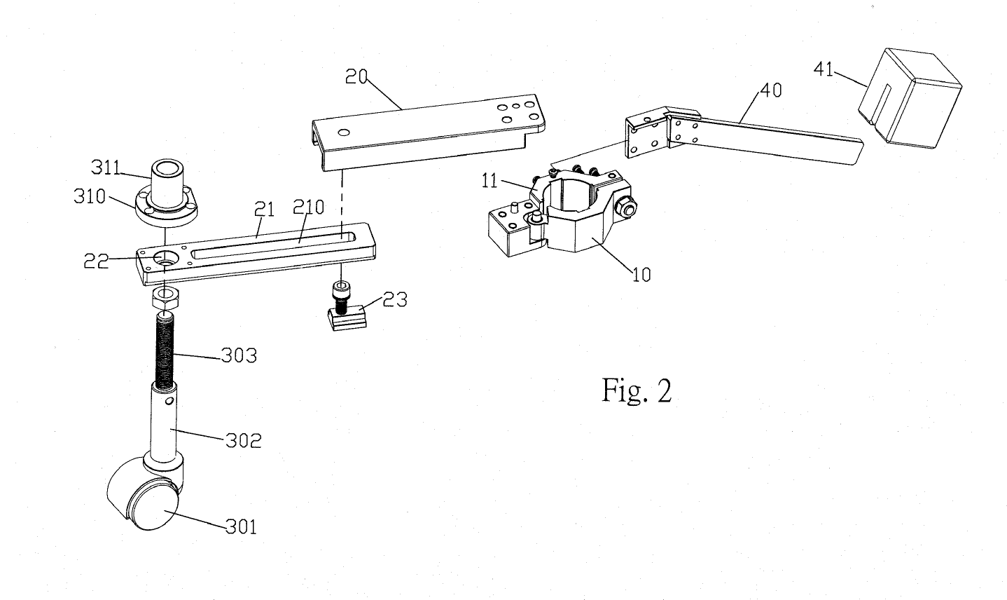

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIGS. 1, 2 and 3, the connection device for connecting with a chair and assembling with a supporter for supporting electronic devices of the present invention is illustrated. The connection device comprises the following elements.

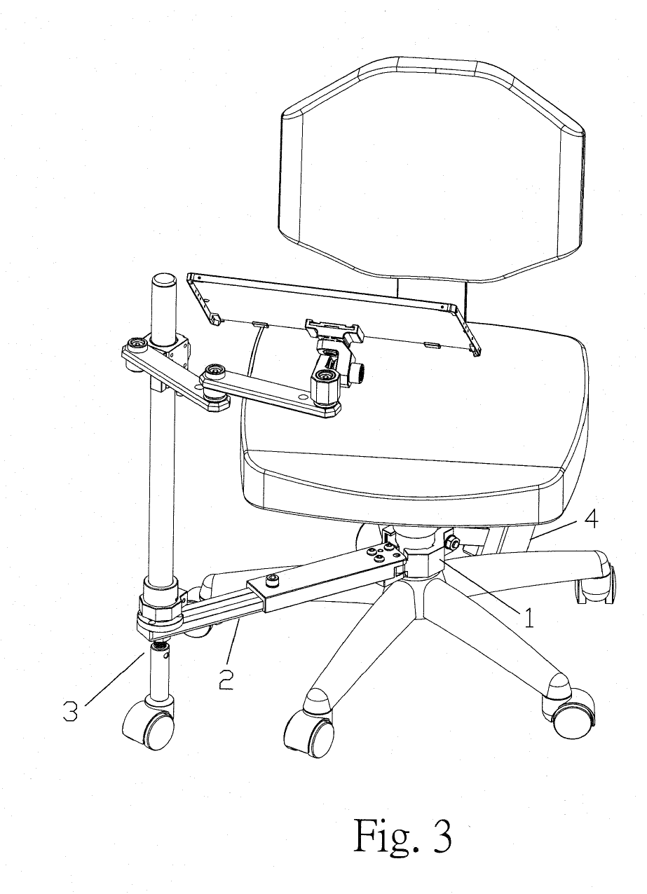

A connection unit 1 is capable to be retained to a leg of a chair (see FIG. 3). The connection unit 1 is formed by an upper connecting unit 10 and a lower connecting unit 11. Each of the upper connecting unit 10 and the lower connecting unit 11 has a semi-round hole. Thus when the upper connecting unit 10 is combined to the lower connecting unit 11, the semi-round hole of the upper connecting unit 10 and the semi-round hole of the lower connecting unit 11 will form as a round hole. Using a screw, one end of the upper connecting unit 10 is combined to one end of the lower connecting unit 11.

A telescopic slider 2 has one end connected to the connection unit 1 and serves for adjusting a distance to a computer chair. The telescopic slider 2 includes the following elements.

An extendable plate 20 has an inverse U shape. One end of the extendable plate 20 is locked to another end of the connection unit 1.

A track 21 has an oblong shape. A middle section of the track 21 has a groove 210. The extendable plate covers upon an upper side of the track 21. One end of the track 21 has a screw hole 22.

A sliding block 23 is positioned below the groove 210 of the track 21. A screw passes through the groove 210 to lock the sliding block 23 to the track 21.

A movable supporter 3 is connected to the another end of the telescopic slider 2. The movable supporter 3 is movable with respective to a roller of a computer chair and is pivotably connected to other element so that an object can be fixed to a computer chair. The movable supporter 3 includes the following elements.

A roller set 30 includes at least one shaft 301 and a roller 302. One end of the shaft 301 is connected to the roller 302 and another end of the shaft 301 is formed with threads 303 for locking to the screw hole 22 of the track 21.

A sleeve 31 has an approximate round seat 310 at a lower end thereof and a hollow tube 311 extended from the seat 310. The seat 310 is fixed at the upper end of the screw hole of the track 21.

A weight 4 includes a connecting rod 40 and a weight unit 41. One end of the rod 40 is connected to the connection unit 1 and another end of the rod 40 is connected to the weight unit.

The present invention is mainly used to connect to a chair and further supported to an object (such as a retainer for retaining a notebook). A seat of the chair is supported by a supporting shaft. A lower end of the supporting shaft is extended with a base which may be for exampled a claw set. Each claw is installed with a rolling wheel so as to provide a firm and steady structure. In use, the connection unit 1 will clamp the shaft of the chair so that the connection assembly of the present invention will be firmly secured to the chair. Then as illustrated in FIG. 3, a plate is connected to the connection device through a plurality of connection means. A computer (not shown) can be placed upon the plate. The weight 4 has the effect of providing a balance to the connection device of the present invention so as to prevent the chair from falling down to one side due to the unbalance from the connection device of the present invention.

Advantages of the present invention is that the general used chair can be converted into a computer chair (as defined in above background of the invention) by being attached by the connection device of the present invention. Thus a computer (or other electronic device) can be located firmly in front of a chair by which the user can operate the computer (or electronic device) easily and conveniently without any desk. If the chair has rolling wheels on the base thereof, the chair with the computer (or electronic device) is movable so that the user can operate the computer (or electronic device) at any desired place without confinement. Furthermore, since no desk is needed, the space required is saved. If the computer is not used, the connection device can be detached from the chair easily and quickly for storage.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A connection device for connecting with a chair and assembling with a supporter for supporting electronic devices, comprising:
a connection unit for clamping to a leg of a chair;
a telescopic slider having one end connected to the connection unit and for adjusting a distance to the chair; and
a movable supporter connected to the another end of the telescopic slider; the movable supporter being movable with respective to the chair and being pivotably connected to other element so that an object can be fixed to the chair.

2. The connection device as claimed in claim 1, wherein the connection unit is formed by an upper connecting unit and a lower connecting unit; each of the upper connecting unit and the lower connecting unit has a semi-round hole; thus when the upper connecting unit is combined to the lower connecting unit, the semi-round hole of the upper connecting unit and the semi-round hole of the lower connecting unit will form as a round hole; by using a screw, one end of the upper connecting unit is combined to one end of the lower connecting unit.

3. The connection device as claimed in claim 2, wherein the telescopic slider includes:
an extendable plate having an inverse U shape; one end of the extendable plate being locked to another end of the connection unit;
a track having an oblong shape; a middle section of the track having a groove; the extendable plate covering upon an upper side of the track; and one end of the track having a screw hole; and
a sliding block positioned below the groove of the track; a screw passing through the groove to lock the sliding block to the track.

4. The connection device as claimed in claim 3, wherein the movable supporter includes:
a roller set having at least one shaft and a roller; one end of the shaft being connected to the roller and another end of the shaft being formed with threads for locking to the screw hole of the track; and
a sleeve having an approximate round seat at a lower end thereof and a hollow tube extended from the seat; and the seat being fixed at an upper end of the screw hole of the track.

5. The connection device as claimed in claim 1, further comprising: a weight including a connecting rod and a weight unit; one end of the rod being connected to the connection unit and another end of the rod being connected to the weight unit.
